(19) United States
(12) Patent Application Publication
(10) Pub. No.: US 2014/0337974 A1
(43) Pub. Date: Nov. 13, 2014

(54) SYSTEM AND METHOD FOR SEMANTIC INTEGRATION OF HETEROGENEOUS DATA SOURCES FOR CONTEXT AWARE INTRUSION DETECTION

(71) Applicants: Anupam JOSHI, Ellicott City, MD (US); Timothy Wilkin FININ, Ellicott City, MD (US); Mary Lisa Mathews, Elkridge, MD (US)

(72) Inventors: Anupam JOSHI, Ellicott City, MD (US); Timothy Wilkin FININ, Ellicott City, MD (US); Mary Lisa Mathews, Elkridge, MD (US)

(21) Appl. No.: 14/253,569

(22) Filed: Apr. 15, 2014

Related U.S. Application Data
(60) Provisional application No. 61/811,933, filed on Apr. 15, 2013.

(51) Int. Cl. H04L 29/06

(52) U.S. Cl. CPC H04L 63/1425; H04L 63/1433
USPC 726/23

(57) ABSTRACT

A semantic approach to intrusion detection is provided that can utilize traditional as well as nontraditional data sources collaboratively. The information extracted from these traditional and nontraditional data sources is expressed in an ontology, and reasoning logic rules that correlate at least two separate and/or distinct data sources are used to analyze the extracted information in order to identify the situation or context in which an attack can occur. By utilizing reasoning logic rules that contain rules that correlate at least two separate and/or distinct data sources, a threat or attack can be determined using data that is spatially (e.g., geographically) and temporally separated, resulting in a context aware IDPS that can relate disparate activities spread across time and multiple systems as part of the same attack.

This application claims priority to U.S. Provisional Application Ser. No. 61/811,933 filed Apr. 15, 2013, whose entire disclosure is incorporated herein by reference.

### BACKGROUND OF THE INVENTION

1. Field of the Invention

The present invention relates to intrusion detection and prevention systems (IDPSs) and, more specifically, to IDPSs that utilizes data from heterogeneous data sources collaboratively to provide context aware intrusion detection. The present invention also relates to responses to intrusions, such as remediation.

2. Background of the Related Art

The Background of the Related Art and the Detailed Description of Preferred Embodiments below cite numerous technical references, which are listed in the Appendix below. The numbers shown in brackets (“[ ]”) refer to specific references listed in the Appendix. For example, “[1]” refers to reference “1” in the Appendix below. All of the references listed in the Appendix below are incorporated by reference herein in their entirety.

As we incorporate computers into more aspects of our lives, security attacks that target these systems become more invasive and damaging. An IDS is a set of tools that runs passively in the background to determine if components of a system, as reflected in the system data, such as network or host monitoring data, are behaving maliciously. When an IDS runs passively, it notes potential security breaches and logs them or notifies an operator but takes no action to prevent or mitigate the problem. For example, if an IDS detects the unauthorized transfer of packets over the network, it takes no action against the flow of traffic or the hosts on the network. Active systems, referred to as Intrusion Prevention Systems (IPSs), seek to stop malicious behavior and traffic before harm is done. IDS and IPS systems usually work in conjunction to form and IDPS. Additionally, the human operators of a system might also take measures of remediation against the detected attack.

IDPSs are one way to safeguard the cyber-systems we use, but they have limitations. Current state-of-the-art IDPSs perform a simple analysis of host or network data and then flag an alert. Only known attacks whose signatures have been identified and stored in some form can be discovered by most of these systems. Many times an attack is only revealed after some amount of damage has already been done. Also, traditional IDPSs are point-based solutions incapable of utilizing information from multiple data sources and have difficulty discovering newly published or zero-day attacks. Recent security attacks follow a low-and-slow intrusion pattern where, instead of doing as much damage as quickly as possible, the goal is to remain undetected for as long as possible and slowly weaken a system's defenses. Traditional intrusion detection and prevention systems have difficulty discovering and stopping these types of attacks.

### SUMMARY OF THE INVENTION

An object of the invention is to solve at least the above problems and/or disadvantages and to provide at least the advantages described hereinafter.

Therefore, an object of the present invention is to provide a system and method for detecting cyber intrusions.

Another object of the present invention is to provide a system and method for preventing cyber intrusions.

Another object of the present invention is to provide a system and method for detecting and preventing cyber intrusions.

Another object of the present invention is to provide a system and method for detecting and responding to/remediating cyber intrusions

Another object of the present invention is to provide a system and method for detecting cyber intrusions that collaboratively utilizes information from heterogeneous data sources.

Another object of the present invention is to provide a system and method for detecting cyber intrusions that collaboratively utilizes information from traditional and nontraditional data sources.

Another object of the present invention is to provide a system and method for detecting cyber intrusions that collaboratively utilizes information from structured and unstructured data sources.

Another object of the present invention is to provide a system and method for detecting cyber intrusions that collaboratively utilize non-text-based data sources and text-based data sources.

Another object of the present invention is to provide a system and method for semantic integration of heterogeneous data sources.

Another object of the present invention is to provide a system and method for semantic integration of traditional and nontraditional data sources.

Another object of the present invention is to provide a system and method for semantic integration of structured and unstructured data sources.

Another object of the present invention is to provide a system and method for semantic integration of non-text-based data sources and text-based data sources.

Another object of the present invention is to provide a system and method for detecting cyber intrusions that utilizes information from heterogeneous data sources to infer the context of the system being monitored and use the context to determine if the context represents an attack.

To achieve at least the above objects, in whole or in part, there is provided a method of detecting a potential cyber threat or attack, comprising receiving data from at least two data sources, extracting information from the received data, asserting the information extracted using an ontology, accumulating the asserted information and determining if a cyber threat or attack is present based on the received data, the accumulated asserted information and reasoning logic rules, wherein the reasoning logic rules comprise rules that correlate at least two separate and/or distinct data sources.

To achieve at least the above objects, in whole or in part, there is also provided an intrusion detection system, comprising a collaborative processing system adapted to receive data from at least two data sources, an ontology comprising a set of computer readable instructions stored in a tangible medium that are executable by a processor and reasoning logic rules comprising a set of computer readable instructions stored in a tangible medium that are executable by a processor, wherein the reasoning logic rules comprise at least two separate and/or distinct data sources, wherein the collaborative processing system is further adapted to extract information from the received data, assert the extracted information using the ontology, accumulate the asserted information and determine if a cyber threat or attack is present based on the received data, the accumulated asserted information and the reasoning logic rules.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram that illustrates the major components of a context aware IDS 100, in accordance with one preferred embodiment of the present invention;

FIG. 2A is a block diagram showing examples of network activity monitors, in accordance with one preferred embodiment of the present invention;

FIG. 2A is a block diagram showing examples of traditional data sources, in accordance with one preferred embodiment of the present invention;

FIG. 2B is a block diagram showing examples of nontraditional data sources, in accordance with one preferred embodiment of the present invention;

FIG. 3 is a block diagram of a collaborative processing system, in accordance with one preferred embodiment of the present invention;

FIG. 4 is a flowchart illustrating steps in the operation of the context aware IDS, in accordance with one preferred embodiment of the present invention;

FIG. 5 shows a free text description from the CVE-2012-2557, which is available from the National Vulnerability Database;

FIG. 6 shows a reasoning logic rule used by the reasoning logic module, serialized as N3, that asserts RDF triples describing a potential attack based on the presence of triples representing the state of the system and recent events, in accordance with one preferred embodiment of the present invention;

FIG. 7 is a high level overview schematic of the ontology used by the collaborative processing system, in accordance with one preferred embodiment of the present invention;

FIGS. 8A and 8B show unstructured text data input to the entity and concept analyzing module;

FIGS. 9A and 9B shows the named entities extracted by the entity and concept analyzing module from the CVE text description and the Juniper Networks link text description, respectively;

FIGS. 10A-10C show a summary of an Adobe attack, the unstructured text data used, and the steps executed by the system, respectively, to conclude the occurrence of an attack, in accordance with one preferred embodiment of the present invention;

FIG. 11 shows an example of a reasoning logic rule used by the reasoning logic module to determine the occurrence of an attack, in accordance with one preferred embodiment of the present invention;

FIGS. 12A-12D show additional examples of reasoning logic rules used by the reasoning logic module to determine the occurrence of an attack, in accordance with one preferred embodiment of the present invention;

### DETAILED DESCRIPTION OF PREFERRED EMBODIMENTS

Throughout the specification, the singular and plural versions of the terms “data source”, “data channel”, “sensor” and “monitor” are used interchangeably and all refer to a source of information or data that can be used by the various components and modules of the various embodiments disclosed herein.

The present invention provides a semantic approach to intrusion detection that uses traditional as well nontraditional sensors collaboratively [1]. Nontraditional sensors or data sources are generally defined herein as sources of information that contain text descriptions (hereinafter referred to as “text data”) of known or potential cyber threats and/or cyber vulnerabilities. These have not been previously used to detect, prevent, or remediate cyber intrusions, hence the term “nontraditional.” The text data can be structured or unstructured text data. Unstructured text data is generally defined herein as text data that is in a narrative format. Structured text data is defined herein as text data that has been categorized and/or organized based on predetermined categories and/or formats. Semi-structured text data is text data that includes both structured and unstructured text data.

An example of a nontraditional data source that provides semi-structured text data is vulnerability management data repository, such as the National Vulnerability Database (NVD) and its associated components, including the Common Vulnerabilities and Exposures (CVE), Common Weakness Enumeration (CWE) and Product Dictionary (CPE) datasets [2]. These resources provide structured text data in that they list vulnerabilities and exposures, categorize them by type and severity, provide common names and identifiers, include links to patches and other information and have details as short text descriptions. The structured text data from these resources are typically provided in XML data feeds.

However, these resources also contain unstructured text data in which important information could be embedded such as, for example, the systems that are likely to be affected, the operating systems environment for which the attack can occur, the versions of the products affected and the relationships between these entities. Examples of nontraditional data sources that generally only provide unstructured text data include, but are not limited to, online forums, blogs, security bulletins, hacker forums and chat rooms.

Traditional data sources are generally defined herein as any data source that does not fit the definition of a nontraditional data source, as described above. Examples of traditional data sources include, but are not limited to, network activity monitors, host based activity monitors, hardware security sensors and IDPSs such as Snort® and Norton AntiVirus. One aspect of the present invention is expressing the text data obtained from nontraditional data sources in a structured, semantic, machine-understandable format, and collaboratively utilizing this data with data from traditional data sources to detect and/or prevent cyber intrusions.

After analyzing the data from these sensors, the information extracted is added to a knowledge base. Reasoning logic rules, which correlate multiple separate and/or distinct data sensors, are also stored in the knowledge base. The extracted information and the reasoning logic rules are used to identify the situation or context in which an attack can occur. The reasoning logic rules are preferably expressed in the same ontology as that used for representing the data. By having separate and/or distinct data sources collaborate to discover potential security threats and create additional signatures, a threat or attack can be determined using data that is spatially (e.g., geographically) and temporally separated. This results in a context aware IDPS that is better equipped to stop creative attacks, such as those that follow a low-and-slow intrusion pattern.

Intrusion detection and prevention systems like Snort® [3] and IBM® X-Force [4] are signature-based systems that monitor a system's behavior and compares it with a predefined notion of acceptable behavior. If the system deviates from the predefined and fixed description of acceptable behavior, an associated set of anomalous activities is checked, and an alert is raised if the current activity is found in that set. Though most of these IDS/IPS systems have well defined attack update mechanisms that keep them current with information on new attacks, they face certain limitations.

These systems cannot detect threats in the infrastructure if the signature of the threat is not present in the system database. Apart from the traditional IDS and IPS systems, there are many other host and network based activity monitors such as Wireshark® [5], Nagios® [6] and Cacti® [7] that provide elaborate data logs of the activities being performed at the host/network level. These monitoring tools also have a rule-based alerting mechanism, where the activities in the infrastructure are monitored and checked against a pre-defined set of rules, and corresponding actions are taken when certain events satisfy certain rules. Unless the behavior of the attack is known, these systems cannot detect it.

The present invention integrates: (1) conventional signature-based intrusion detection, which utilize traditional data sources; (2) relevant information extracted from nontraditional data sources; and (3) ontological reasoning using reasoning logic rules over the aggregated traditional and/or nontraditional data. The resulting system and method can link and infer means and consequences of cyber threats and vulnerabilities whose signatures are not yet available. The present invention is a context aware IDPS that can relate disparate activities spread across time and multiple systems as part of the same attack.

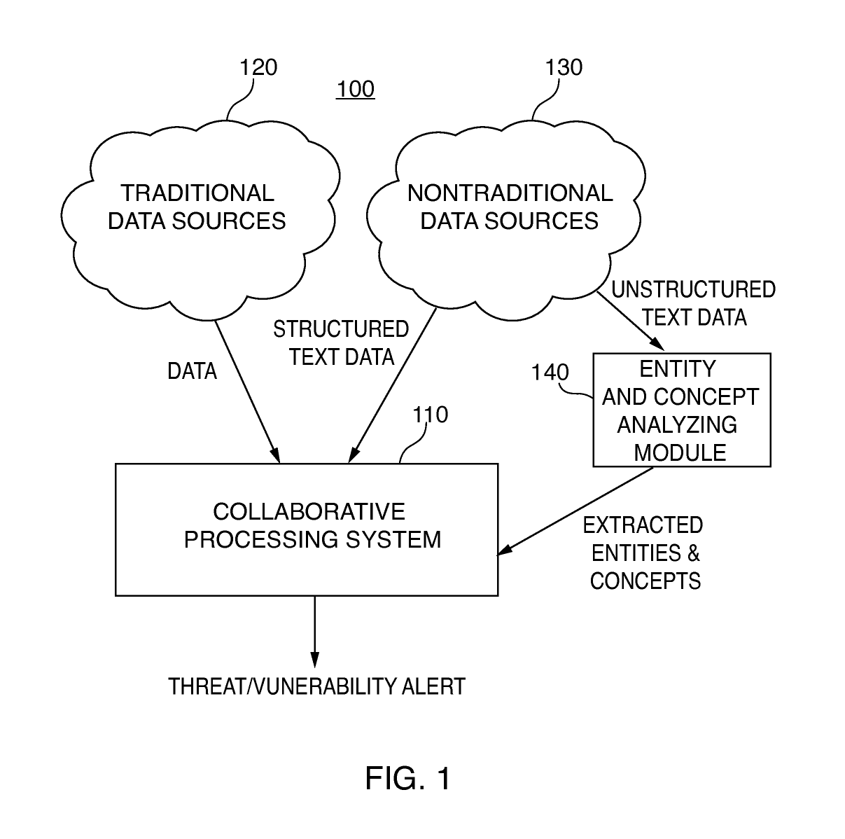

FIG. 1 is a block diagram that illustrates the major components of a context aware IDS 100, in accordance with one preferred embodiment of the present invention. The system 100 includes a collaborative processing system 110 that is capable of receiving data from traditional data sources 120 and nontraditional data sources 130. The system 100 also preferably includes an entity and concept analyzing module 140 that receives unstructured text data from nontraditional data sources 130 and outputs extracted entities and concepts (relevant information events) to the collaborative processing system 110. The entity and concept analyzing module 140 will be discussed in more detail below.

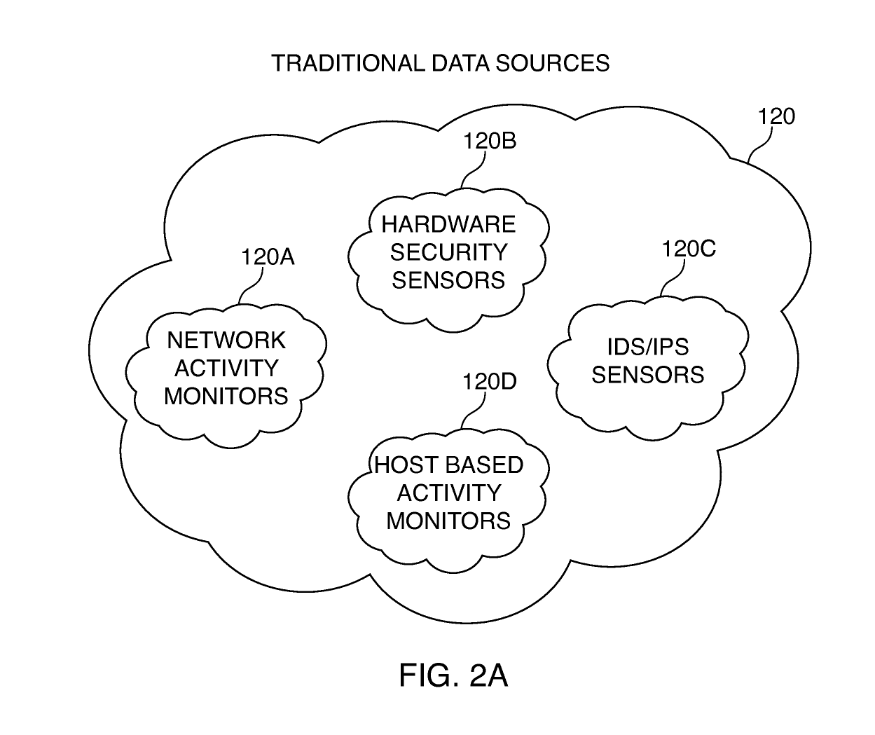

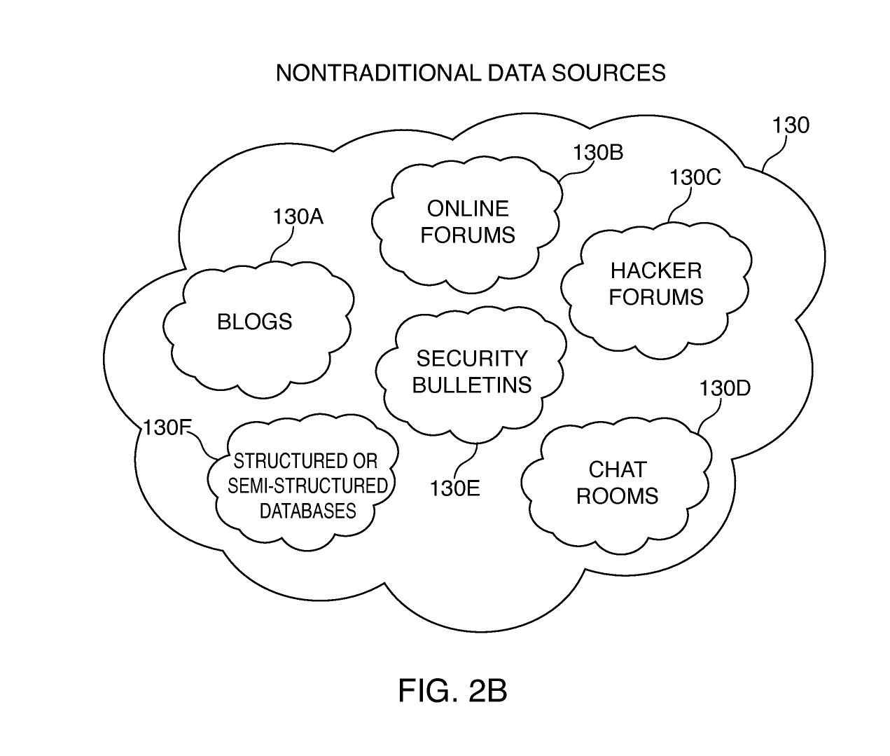

The traditional data sources 120 and nontraditional data sources 130 can be deployed enterprise wide and also across enterprise boundaries. FIG. 2A shows examples of traditional data sources 120. The traditional data sources 120 can include, but are not limited to, network activity monitors 120A, hardware security monitors 120B, IDS/IPS sensors 120C and host based activity monitors 120D.

Examples of network activity monitors 120A include, but are not limited to, Wireshark®, Nagios® and Cacti®. An example of a hardware security sensor 120B is the Cisco® IPS 4200 [8]. Data from IDS/IPS sensors 120C preferably provide verbose information related to one or more of the following: (1) the system and network traffic; (2) the data packets sent and received by the system; (3) the source and destination ports/IPs; (4) the type of hardware at the source and destination; (5) protocols of communication; and (6) time-stamp related information. In addition, anomaly-based IDSs may also be used as an IDS/IPS sensor 120C. The host based activity monitors 120D preferably provide information related to activities/processes that are executing at the host, such as logs from top [9] and monit [10].

FIG. 2B shows examples of nontraditional data sources 130. The nontraditional data sources 130 can include, but are not limited to, blogs 130A, online forums 130B, hacker forums 130C, chat rooms 130D, security bulletins 130E and structured or semi-structured databases 130F.

Blogs 130A, online forums 130B, hacker forums 130C, chat rooms 130D and security bulletins 130E will typically output unstructured text data, which is preferably processed by the entity and concept analyzing module 140, as will be explained in more detail below. Structured or semi-structured databases 130F output structured text data, such as well-defined threat/attack data, and possibly unstructured text data as well. Any unstructured text data output by a semi-structured database 130F is preferably processed by the entity and concept analyzing module 140, as will be explained in more detail below.

Referring back to FIG. 1, the collaborative processing system 110 aggregates the data from the data sources, applies reasoning logic to the aggregated data and detects potential threats/intrusions based on the reasoning logic applied to the aggregated data.

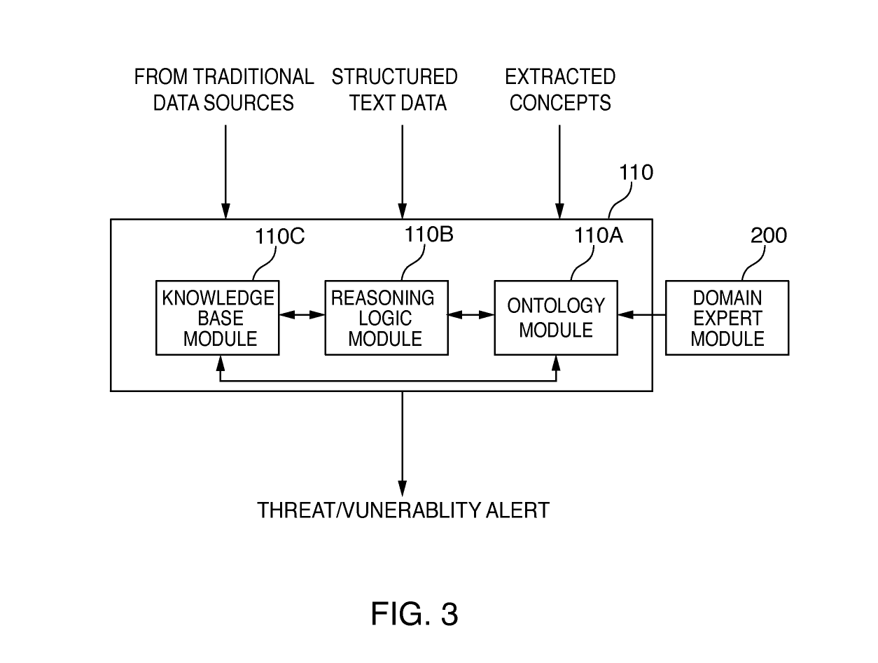

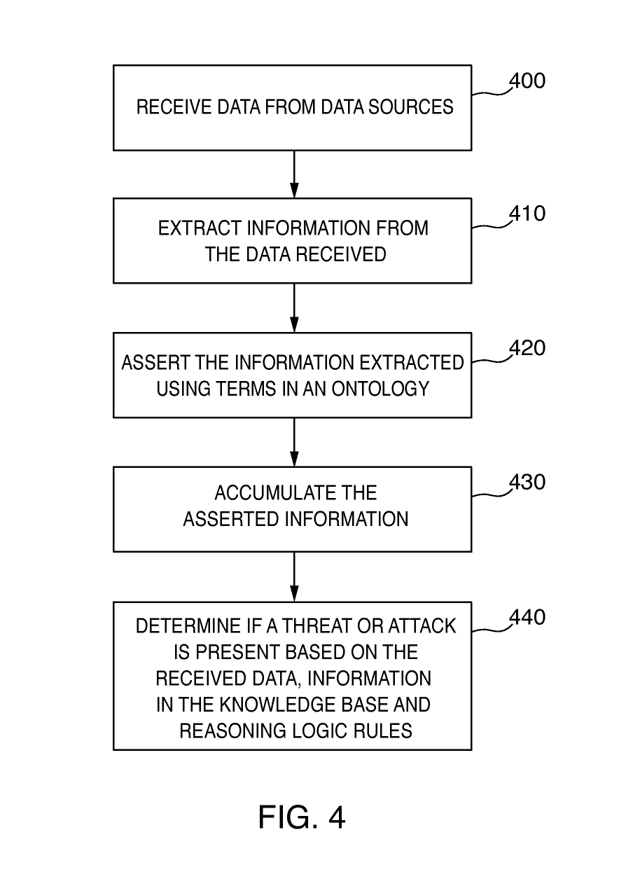

FIG. 3 is a block diagram of one preferred embodiment of the collaborative processing system 110, and FIG. 4 is a flowchart illustrating steps in the operation of the context aware IDS 100, in accordance with one preferred embodiment of the present invention. The steps in FIG. 4 will be described below in the context of the context aware IDS system 100 shown in FIG. 1 and the collaborative processing system 110 shown in FIG. 3.

The collaborative processing system 110 preferably includes an ontology module 110A, a reasoning logic module 110B and a knowledge base module 110C. The ontology module 110A utilizes an ontology that extends the ontology described in [11] and [12] by adding rules to the reasoning logic. An ontology generally refers to the representation of knowledge as a hierarchy of concepts within a domain, using a shared vocabulary to denote the types, properties and interrelationships of those concepts.

The ontology language used by the ontology module 110A is preferably Web Ontology Language (OWL) [13], however any type of ontology language can be used. The ontology used by the ontology module 110A preferably includes 3 fundamental classes: ‘means’, ‘consequences’, and ‘targets’. The ‘means’ class encapsulates the ways and methods used to perform an attack, the ‘consequences’ class encapsulates the outcomes of the attack, and the ‘target’ class encapsulates the information of the system under attack. For example, the ‘means’ class consists of sub-classes like ‘BufferOverFlow’, ‘synFlood’, ‘LogicExploit’, ‘tcpPortScan’, etc., which can further consist of their own sub-classes; the ‘consequences’ class consists of sub-classes like ‘DenialOfService’, ‘LossOfConfiguration’, ‘PrivilegeEscalation’, ‘UnauthUser’, etc.; and the ‘targets’ class consists of sub-classes like ‘SystemUnderDoSAttack’, ‘SystemUnderProbe’, ‘SystemUnderSynFloodAttack’, etc.

At step 400 in FIG. 4, data is received from data sources, which can be traditional data sources 120 and/or nontraditional data sources 130. Then, at step 410, relevant information is extracted from the data received. Next, at step 420, the information extracted is asserted using terms in the ontology. At step 430, the asserted information is accumulated.

Steps 400-430 are preferably implemented by the ontology module 110A, which extracts information from the data streams received from the traditional data sources 120 and the nontraditional data sources 130, asserts the extracted information using the terms in the ontology and adds the asserted information to the knowledge base in the knowledge base module 110C, thereby accumulating the asserted information. Any unstructured text data received at step 400 is preferably processed at step 410 by the entity and concept analyzing module 140, as will be explained in more detail below.

The entities that are collected from the data streams are asserted into one of the classes based on the properties of the class and the meaning of the entity. For example, ‘annots.api executible’ is an object of a class ‘process under stack overflow’, which is a subclass of ‘buffer overflow’, which in turn is a subclass of ‘means’ class. Similarly, ‘remote execution’ is a subclass of ‘remote to local’ class, which in turn is a subclass of ‘unauthorized user access’ class, which in turn is a subclass of ‘consequence’ class. Likewise, system being monitored is an object of ‘system under remote attack’, which is a subclass of ‘system under unauthorized user access’, which in turn is a subclass of ‘targets’ class.

The information from the different data steams is encoded in some serialization of the semantically rich ontology, such as the Notation-3 format. The knowledge base in the knowledge base module 110C is built up by preferably encoding the information in OWL and Resource Description Framework (RDF) [14] assertions. The assertions are preferably serialized using Notation 3 (N3) [15] triples of the form “subject (s) predicate (p) object (o),” that assets that the relation p holds between s and o. The serialization is preferably performed via an Extensible Stylesheet Language Transformation and the Jena RDF API [24].

For example, FIG. 4 shows a free text description from the CVE-2012-2557, which is available from the National Vulnerability Database (NVD). Our entity and concept analyzing module 140 (FIG. 1) and ontology module 110A can analyze this description and extract the fact that the software product Internet Explorer 6 has the use-after-free vulnerability, and place this extraction into the knowledge base module 110C. In our ontology, the ‘user-after-free vulnerability’ is an instance of the class ‘Backdoor’, which is a subclass of ‘MaliciousCodeExecution’, which in turn is a subclass of ‘Means’ class. The reasoning logic module 110B is preferably able to deduce that this is the means of some potential attack. Data from the traditional data sources 120 and nontraditional data sources 130 are used to continuously update the knowledge base in the knowledge base module 110C via the ontology module 110A.

Referring back to FIG. 4, at step 440 it is determined if a threat or attack is present based on the received data, information on the knowledge base and reasoning logic rules. This step is preferably implemented with the reasoning logic module 110B, which receives data from the traditional data sources 120 and/or the nontraditional data sources 130, receives knowledge asserted into the knowledge base from the knowledge base module 110C, and receives reasoning logic rules to determine the possibility of a threat or attack. The reasoning logic rules are preferably expressed in the ontology by the ontology module 110A and stored in the knowledge base present in the knowledge base module 110C.

“Reasoning logic rules” are defined as rules that correlate at least two separate and/or distinct data sources. “Separate” data sources refers to two or more separate data sources that are of the same type. For example, two host based activity monitors would be considered two separate data sources. “Distinct” data sources refer to two or more data sources that are of a different type. For example, a host based activity monitor and an IDS would be two distinct data sources. By utilizing reasoning logic rules that contain rules that correlate at least two separate and/or distinct data sources, a threat or attack can be determined using data that is spatially (e.g., geographically) and temporally separated.

The reasoning logic rules expressed in the ontology from the ontology module 110A preferably originate from domain experts (domain expert knowledge 200). For example, computer forensics experts detect many complex attacks by combing evidence from various different logs and traces. These complex rules operate across a variety of data sources and at a high level of abstraction. For instance, a rule could say that if blogs are describing potential flaws in some software X and that same software X is installed on a computer and its corresponding process Y is opening connection to a previously never connected IP address in country Z, then there is an attack. This is very distinct from signature specific, single source rules in existing IDSs such as Snort. The reasoning logic rules are preferably expressed in the ontology and an appropriate rule language (suitably Jena rules [16]). The reasoning logic module 110B looks at the rules from the knowledge base in the knowledge base module 110C, as well as the data gathered from the traditional data sources 120 and/or nontraditional data sources 130, to flag an alert, giving the means, consequences, and targets of the potential attack. The knowledge base in the knowledge base module 110C that is built up by asserting the ontology is used by these rules to derive chains of implications. Instances are asserted into the knowledge base module 110C as events occur.

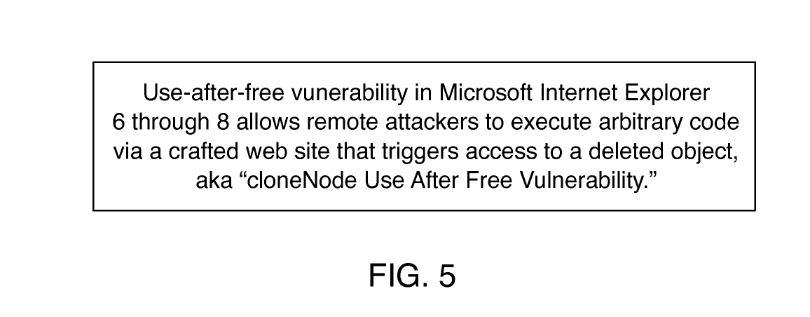

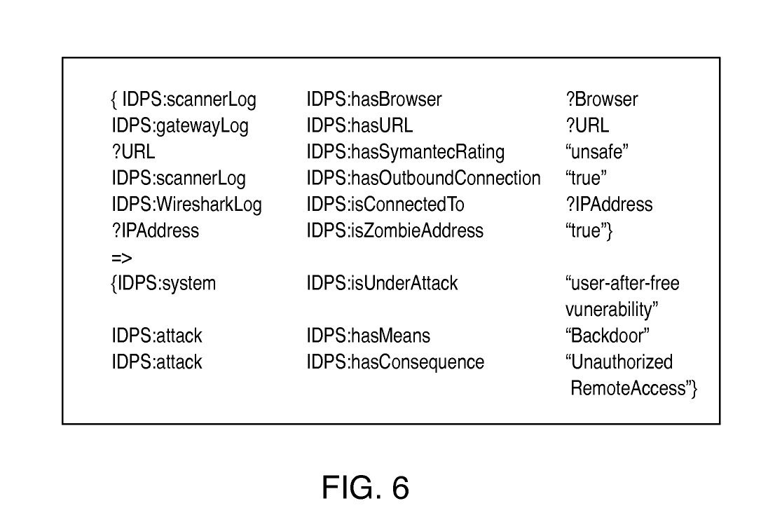

For example, consider the IE6 vulnerability described in FIG. 5. A reasoning logic rule that accounts for this threat, such as the reasoning logic rule shown in FIG. 6, could state that if an affected version of Internet Explorer is running (as detected by a host based activity monitor 120D), the user has visited a previously unvisited site (as detected by an application level gateway) that has a negative reputation (as reported by commercial providers such as Symantec), and a connection has subsequently been opened to machine in a known range of zombie addresses (for example, as detected by a Wireshark® and SORBS), an attack is likely occurring.

The knowledge base module 110C can also be dynamically queried by an analyst using the SPARQL [17] RDF query language. SPARQL queries consist of triple patterns consisting of a subject, predicate and object that are URIs, literals or variables (terms beginning with a ‘?’, along with conjunctions, disjunctions, and optional patterns). If there are any triples in the knowledge base that match the query, either as the result of an assertion of a fact or a derivation of rules resulting from the chain of implication, the value of those triples will be returned.

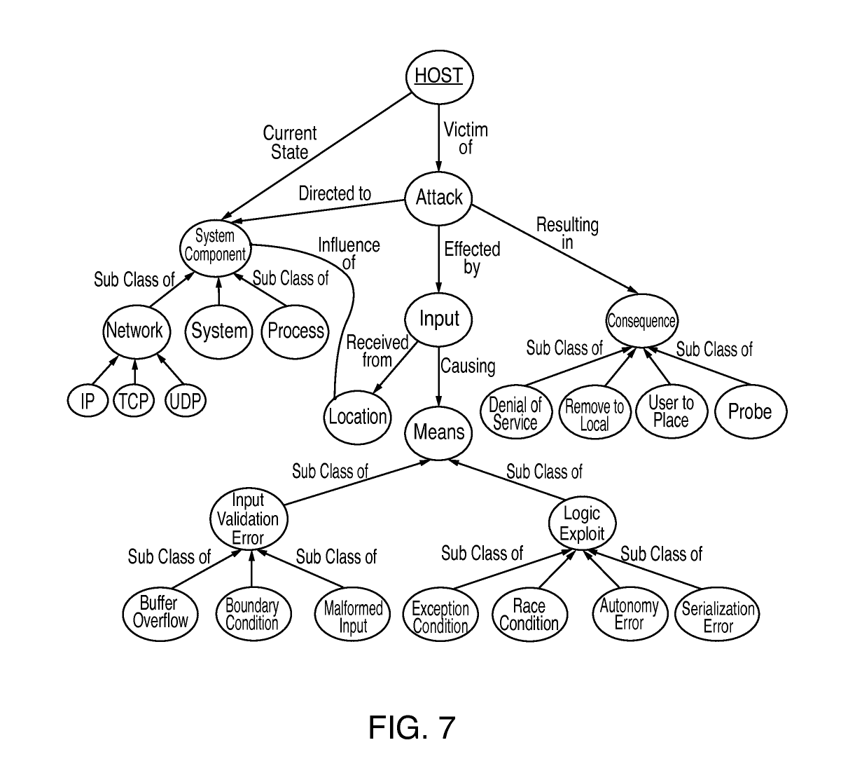

FIG. 7 shows an example of an ontology backbone of the collaborative processing system 110 [18] [19]. It gives a high-level overview of the reasoning mechanism being used by the reasoning logic module 110B for analysis and result deduction. Each of the classes of the ontology have properties which give important information regarding that class. For example, the ‘system’ class has properties like ‘hasMaliciousProcess’, ‘maliciousProcessDetails’, ‘hasAffectedProduct’, ‘affectedProductDetails’, ‘outboundAccess’, ‘portDetails’ etc. which map information from a network activity monitor 120A and unstructured text data from a nontraditional data source 130.

### Operation of the System 100

The system 100 was tested by simulating an attack in a controlled environment on a local network (a private Ethernet based network consisting of 2 desktop machines and an IBM ES750 Network Scanner) and observing the results of the system 100, and represents one example of how the system 100 can operate. A vulnerability present in Adobe Acrobat Reader®, CVE-2009-0927 [20], was simulated as it was reproducible in a small controlled environment and has the of characteristics necessary for validation of the system 100. The vulnerability was a stack based overflow in Adobe Acrobat Reader®, which allowed remote executors to execute arbitrary code. The attack resided in the Annots.api plug-in of Adobe Acrobat Reader®. The vulnerability database of the IBM® Proventia Network Scanner was set to a level where it could not detect the CVE-2009-0927 attack directly. The attack payload was embedded in a PDF file and was configured to open up a TCP port for a remote machine on execution. When the attack was simulated, the IBM® Proventia Network Scanner logged the execution of Annots.api, and thereafter port 80 was opened for a remote machine. However, since the IDS vulnerability database did not have the signature for the exploit, the attack was not flagged.

The IBM® Proventia ES750 Network Scanner and Snort were used as the IDS mechanisms (traditional data sources 120). The logs from these systems were also used as packet captures where threats/attacks were not detected. The logs gave us time-stamped host and network information like port/protocol of communication, IPs of source and destination, processes/system-calls invoked at the host, etc.

Web data sources (nontraditional data sources 130) that output unstructured text data, such as vulnerability description feeds (CVE, CCE, CPE, CVSS, XCCDF, OVAL) [2], hacker forums, chat rooms, blogs, etc., were traversed to get a set of named entities out of the unstructured text. The CVE description [20] and a technology blog post [21] were chosen as text from which the named entities were to be extracted. The named entities were then asserted by the ontology module 110A onto the knowledge base module 110C using the terms in the ontology, and were used by the reasoning logic module 110B for decision making.

OpenCalais [22], an open source semantic analysis tool, was used as the entity and concept analyzing module 140. OpenCalais took unstructured text data as input and output a set of named entities. OpenCalais also tried to group the named entities in certain classes. OpenCalais was given unstructured text data from two web links [20], [21].

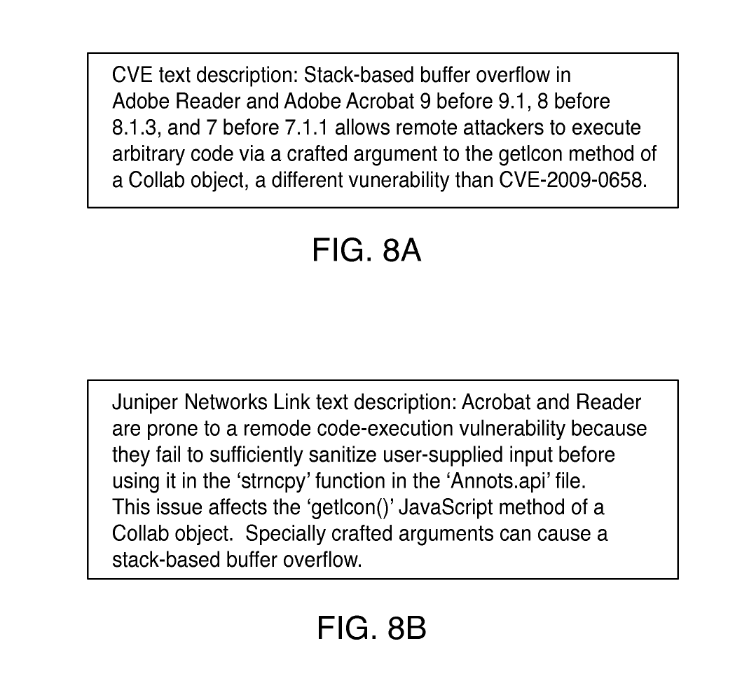

FIGS. 8A and 8B show the unstructured text data given to the entity and concept analyzing module 140. The text shown in FIG. 8A is a CVE text description [20] and FIG. 8B is a Juniper Networks® link text description [21]. The entity and concept analyzing module 140 (OpenCalais) takes the unstructured text data and attaches semantically rich metadata (such as the topic being discussed, entities that pop up in the text, events and facts that occur, etc.) to the content.

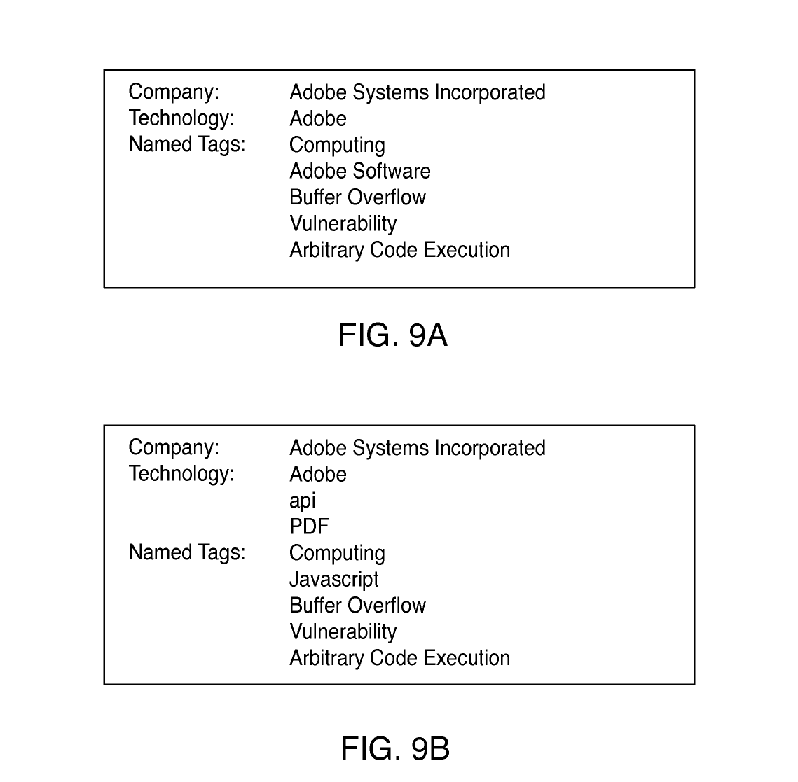

FIGS. 9A and 9B shows the named entities extracted by the entity and concept analyzing module 140 (OpenCalais) from the CVE unstructured text description [20] and the Juniper Networks® link text description [21], respectively. The named entities were mapped to the corresponding means, consequences, and targets classes of the ontology.

The reasoning logic module 110B found the annots.api dll being executed at the host via the logs received from the IBM® Proventia ES750 Network Scanner. The log also pointed out the product using this service, i.e., Adobe Acrobat Reader®. The unstructured text data from the Juniper Networks® link [21] also comprised of ‘annots.api’ in the text. The packet dump showed the opening up of port 80 for clear outbound access after execution of annots.api. The CVE unstructured text description [20] mentioned ‘remote execution’ in the text. The rules in the reasoning logic module 110B could comprise a rule which would flag an alert if there is an opening of outbound network port if the application requesting it inherently does not require a network access for its execution. The reasoning logic module 110B linked the occurrence of Annots.api in the packet dump from IDS, the opening up of port 80, and the output of the entity and concept analyzing module 140 (OpenCalais) to conclude that it is a probable attack on the system.

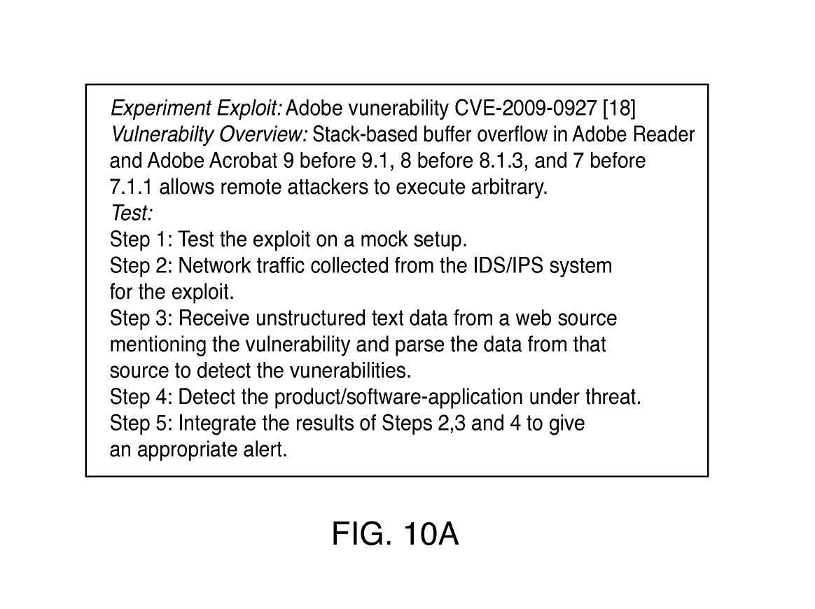

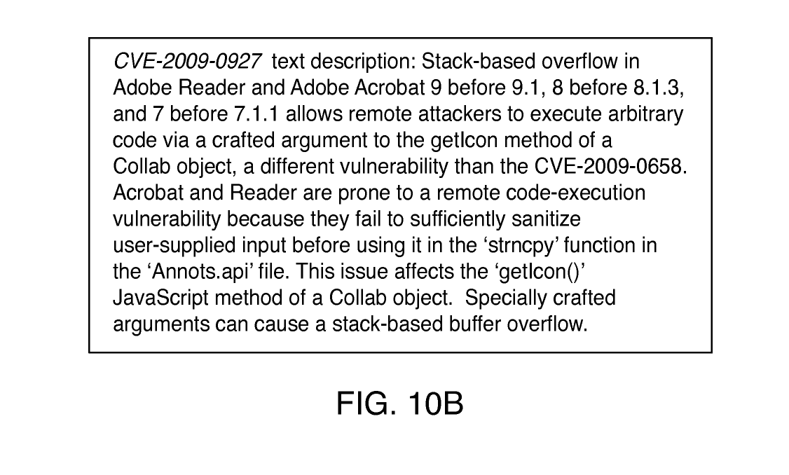

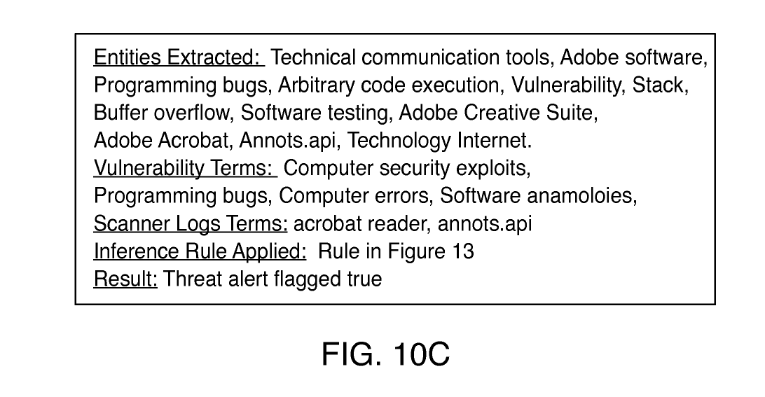

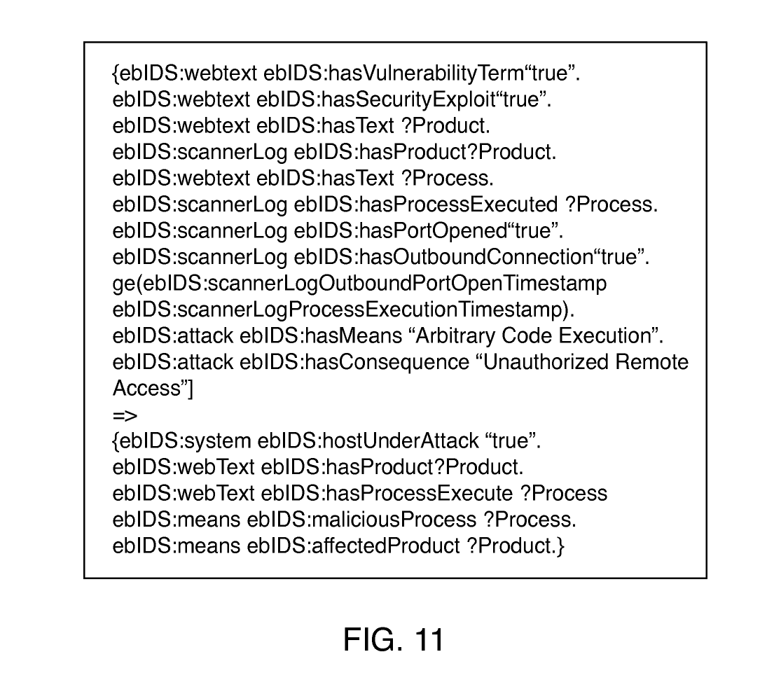

FIGS. 10A-10C show a summary of the Adobe attack, the unstructured text data used, and the steps executed by the system 100, respectively, to conclude the occurrence of an attack. The named entities extracted from the entity and concept analyzing module 140 (OpenCalais) and the IBM® Proventia ES750 Network Scanner are asserted into the knowledge base module 110C in the form of N3-triples by the ontology module 110A, and the reasoning logic rule shown in FIG. 11 was used by the reasoning logic module 110B to determine the occurrence of the attack. The reasoning logic rule shown in FIG. 11 states that if the text description consists of some ‘vulnerability terms’, mentions some ‘security exploit’, has a text mentioning a certain product (with some specific version) and some process which is being executed, which in turn is also logged by the scanner, and there is an opening up of an out-bound port; then there is a possibility of an attack on the host system with ‘means’ and ‘consequences’ mentioned in the ontology.

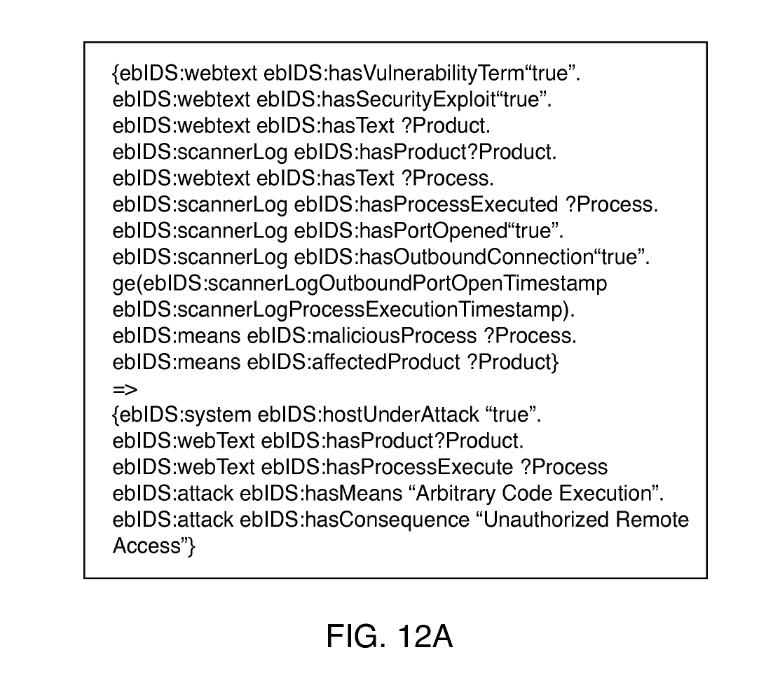

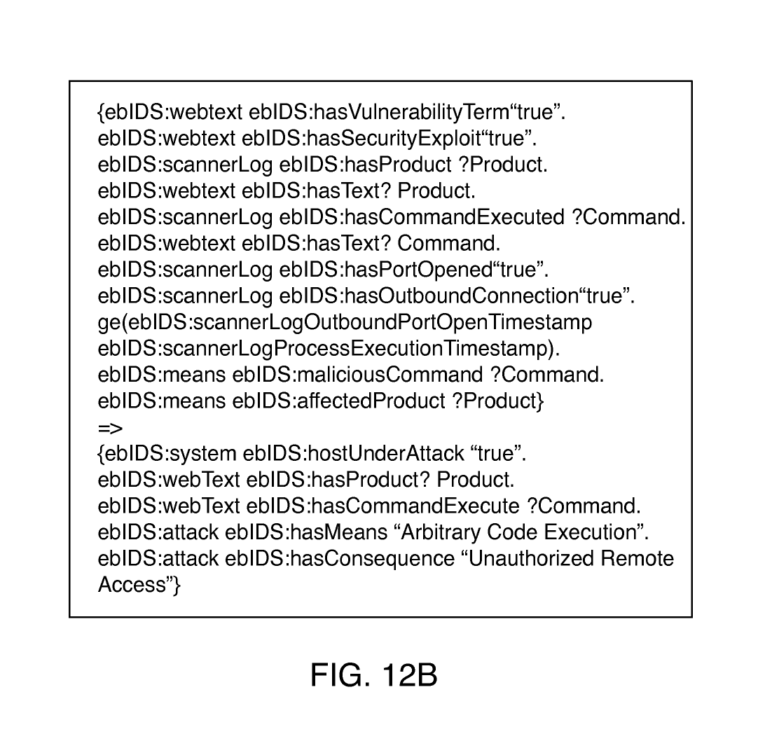

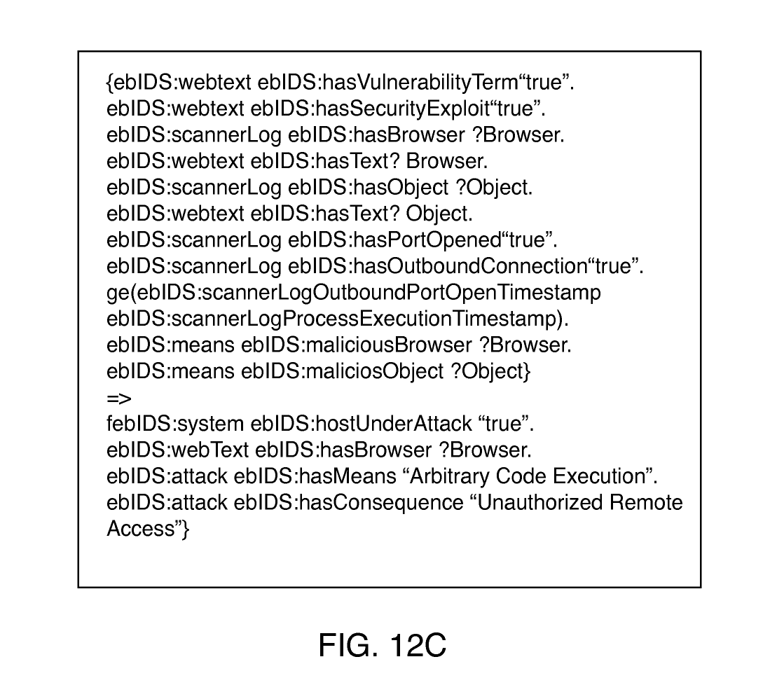

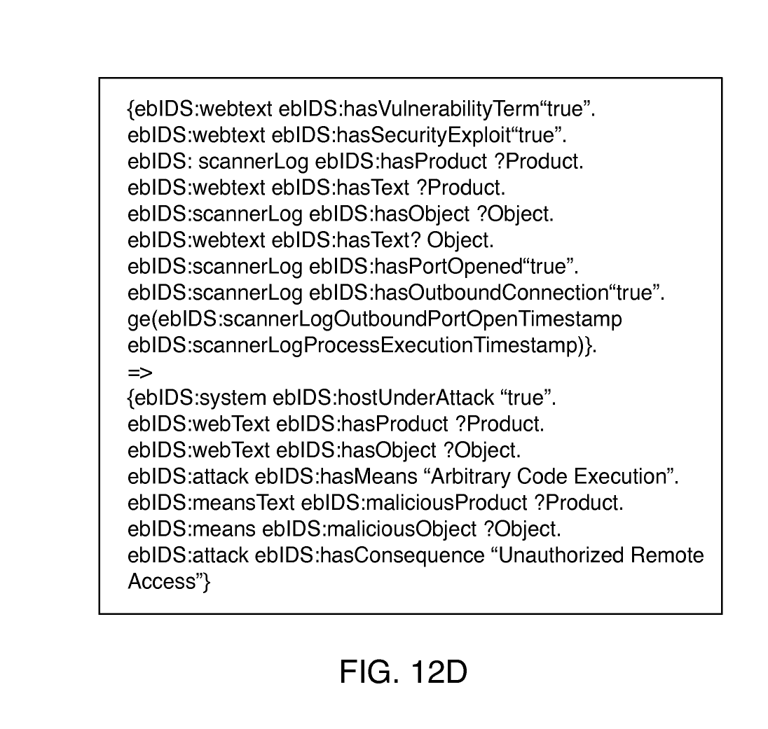

The reasoning logic module 110B was tested on multiple additional vulnerabilities that roughly fell in a similar category. 8,070 separate CVE vulnerability text descriptions [22] were chosen, which mentioned vulnerabilities in different products/platforms/applications that resulted in giving the attacker an unauthorized remote access to the host. The reasoning logic rules shown in FIGS. 12A-12D were used to infer the possibility of an attack. The reasoning logic rule shown in FIG. 12A relates to outbound access (unauthorized remote access) via malicious process execution. The reasoning logic rule shown in FIG. 12B relates to unauthorized remote access/monitoring via malicious command execution. The reasoning logic rule shown in FIG. 12C relates to remote access via browser. The reasoning logic rule shown in FIG. 12D relates to unauthorized remote access/monitoring via malicious object.

The network scanner logs were simulated, i.e. the logs were built up so as to reflect that the data mentioned in the extracted entities and concepts (from the unstructured text data) is true. The reasoning logic module 110B, which used conjunction of the extracted entities and concepts (from the unstructured text data), network monitor logs and the reasoning logic rules in shown in FIGS. 12A-12D was successful in inferring 7,120 of the 8,070 attacks.

### Entity and Concept Analyzing Module

In the tests described above, OpenCalais was used as the entity and concept analyzing module 140. Another preferred embodiment for the entity and concept analyzing module is described in detail in reference [25], which is incorporated by reference herein in its entirety.

The entity and concept analyzing module 140 is preferably implemented using general implementation of a conditional random field (CRF) algorithm provided by Stanford named entity recognizer using a set of features for proper identification of concepts from the input text. Several cybersecurity-related blogs, security bulletins and CVE descriptions were analyzed, and a set of key classes that are relevant in terms of data representation of a vulnerability were identified. Specifically, the following seven classes of relevance were identified:

(1) Software (e.g. Microsoft .NET Framework 3.5)

(a) Operating System (e.g. Ubuntu 10.4)

(2) Network Terms (e.g. SSL, IP Address, HTTP)

### (3) Attack

(a) Means: Way to attack (e.g. Buffer overflow)

(b) Consequences: Final result of an attack (e.g. Denial of Service)

(4) File Name (e.g. index.php)
(5) Hardware (e.g. IBM Mainframe B152)
(6) NER Modifier: This always follows Software or OS and helps in identifying software version information.
(7) Other Technical Terms: Technical terms that cannot be classified in any of the above mentioned classes.

Each of the above classes was chosen to represent key aspects of identification and characterization of the attack. The following described classes are most notable (the classes are shown in italics). Network Terms was identified as an important class since most attacks are now using network technology. Thus, it is important to extract relevant terms in text so that information regarding networks can be identified. An Attack can be further classified as a Means, which helps to identify a method of an attack, or as a Consequence that describes the final result of an attack. For example, “buffer overflow” is considered to be an instance of a Means, since it is not an attacker's final goal, but merely a step to achieve a desired consequence, such as a “denial of service.”

Whether a phrase is considered to be an instance of a Means or Consequence is not always clear in a given text. The annotators used their discretion during annotation. When it was difficult to decide between them for a phrase, it was tagged as an Attack class. In analyzing the gold standard annotation data, it was found that the inter-annotator agreement for these two subclasses was lower than all of the other classes. In this test, we took a random data sample and asked two annotators to annotate the data for four classes (Software Products, Operating System, Means and Consequences). We found the agreement between the annotators to be over 90% for Software Products and Operating System. For Consequences, the agreement was 75%, while for Means it was 52%.

The NER_Modifier class will now be explained. In the text “This vulnerability is present in Adobe Acrobat X and earlier versions . . . ” the phrase “and earlier versions” indicates that all Adobe Acrobat versions before version 10 are also vulnerable to the threat. These words hold key information about other versions that are vulnerable. The NER_Modifier class identifies these terms. It was observed that such terms were generally described immediately before or after a Software term or an Operating System term. Identifying these pieces of text leverages the identification of product versions that may be susceptible to the vulnerability, though are not documented accordingly.

Based on these classes, the extraction framework for the entity and concept analyzing module 140 was trained using the Stanford NER [26], a CRF-based named entity recognition framework that is pre-trained to identify entities such as people, places and organizations. It includes a large feature set that can be customized to train a general implementation of a CRF model. A training dataset consisting of over 30 security blogs, 240 CVE descriptions and 80 official security bulletins from Microsoft and Adobe was chosen. The data corpus [27] was manually annotated by individuals that had a fair understanding of cybersecurity related terms, concepts and technical jargon. A custom application was developed to simplify the annotation process using the BRAT rapid annotation framework [28], [29].

Feature set selection is important in training a NER system. Though the Stanford NER provides an extensive selection of applicable features, filtering a subset that can capture all the relevant information pertaining to the cybersecurity domain is a tedious task. Feature selection is important, as applying all of the available features to the training and test data will not only slow down the annotation process, but also diminish the quality of results. Feature selection for the entity and concept spotted module 140 can suitably be carried out manually by analyzing the text and checking which features would be suitable. One preferred set of features for training the entity and concept spotted module 140 are: useTaggySequences, useNGrams, usePrev, useNext, maxNGramLeng, useWordPairs and gazette.

The colloborative processing system 100 (which includes the ontology module 110A, the reasoning logic module 110B and the knowledge base module 110C) and the entity and concept analyzing module 140 are preferably implemented with one or more programs or applications run by one or multiple processors. The programs or applications are respective sets of computer readable instructions stored in a tangible medium that are executed by one or multiple processors.

The processor(s) can be implemented with any type of processing device, such as a general purpose computer, a special purpose computer, a distributed computing platform located in a “cloud”, a server, a tablet computer, a smartphone, a programmed microprocessor or microcontroller and peripheral integrated circuit elements, ASICs or other integrated circuits, hardwired electronic or logic circuits such as discrete element circuits, programmable logic devices such as FPGA, PLD, PLA or PAL or the like. In general, any device on which a finite state machine capable of running the programs and/or applications used to implement the colloborative processing system 100 and the entity and concept analyzing module 140 can be used as the processor(s).

Further, it should be appreciated that the various modules that make up the context aware IDS 100 could be implemented with a separate processor for each module or any combination of multiple processors. For example, the ontology module 110A, the reasoning logic module 110B and the knowledge base module 110C could be implemented with programs and/or applications running on a common processor. Similarly, the entity and concept analyzing module 140 could be implemented with programs and/or applications running on a processor that is also running programs and/or applications for implementing any number of the other modules in the context aware IDS 100.

The collaborative processing system 110, entity and concept analyzing module 140, as well as the traditional data sources 120 and the nontraditional data sources 130 are all preferably connected to a network through which they communicate with each other and other devices on the network. The network can be a wired or wireless network, and may include or interface to any one or more of for instance, the Internet, an intranet, a PAN (Personal Area Network), a LAN (Local Area Network), a WAN (Wide Area Network) or a MAN (Metropolitan Area Network), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34bis analog modem connection, a cable modem, an ATM (Asynchronous Transfer Mode) connection, an FDDI (Fiber Distributed Data Interface) or CDDI (Copper Distributed Data Interface) connection.

The network may furthermore be, include or interface to any one or more of a WAP (Wireless Application Protocol) link, a GPRS (General Packet Radio Service) link, a GSM (Global System for Mobile Communication) link, CDMA (Code Division Multiple Access) or TDMA (Time Division Multiple Access) link, such as a cellular phone channel, a GPS (Global Positioning System) link, CDPD (Cellular Digital Packet Data), a RIM (Research in Motion, Limited) duplex paging type device, a Bluetooth radio link, an IEEE standards-based radio frequency link (WiFi), or any other type of radio frequency link. The network may yet further be, include or interface to any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection.

The foregoing embodiments and advantages are merely exemplary, and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. Various changes may be made without departing from the spirit and scope of the invention, as defined in the following claims (after the Appendix below).

### APPENDIX

1. S. More, M. Mathews. A. Joshi, and T. Finin; “A Knowledge-based Approach to Intrusion Detection Modeling,” IEEE Symposium on Security and Privacy Workshops, pp. 75-81, May 2012.
2. See http://nvd.nist.gov/, http://cve.mitre.org/, http://cwe.mitre.org/and http://nvd.nist.gov/cpe.cfm.
3. “Snort,” http://www.snort.org/.
4. “Internet security systems x-force security threats,” http://xforce.iss.net.
5. “Wireshark,” http://www.wireshark.org/.
6. “Nagios,” http://www.nagios.org/.
7. “Cacti,” http://cacti.net/.
8. “Cisco hardware sensor,” http://www.cisco.com/en/US/products/hw/vpndevc/ps4077/index.html.
9. “Top command (linux),” http://linux.die.net/man/1/top.
10. “Monit,” http://mmonit.com/monit/.
11. J. Undercoffer, A. Joshi, T. Finin, and J. Pinkston, “Using DAML+OIL to classify intrusive behaviours,” The Knowledge Engineering Review, vol. 18, pp. 221-241, 2003.
12. J. Undercoffer, A. Joshi, and J. Pinkston, “Modeling Computer Attacks: An Ontology for Intrusion Detection,” in Proc. 6th Int. Symposium on Recent Advances in Intrusion Detection. Springer, September 2003.
13. OWL Web Ontology Language Overview. http://w3.org/TR/owlfeatures.
14. RDF. Resource Description Framework. http://www.w3.org/RDF/.
15. N3. Notation 3 Logic. http://www.w3.org/DesignIssues/Notation3.html.
16. Jena. Apache Jena. http://jena.apache.org/index.html.
17. SPARQL. SQARQL Query Language for RDF. http://www.w3.org/TR/rdf-sparq1-query/.
18. J. Undercoffer, A. Joshi, and J. Pinkston, “Modeling Computer Attacks: An Ontology for Intrusion Detection,” in Proc. 6th Int. Symposium on Recent Advances in Intrusion Detection. Springer, September 2003.
19. http://ebiquity.umbc.edu/ontologies/cybersecurity/ids/.
20. “Adobe acrobat vulnerability cve-2009-0927,” http://web.nvd.nist.gov/view/vuln/detail?vulnId=CVE-2009-0927.
21. “Juniper website text description of cve-2009-0927,” http://www.juniper.net/security/auto/vulnerabilities/vuln34169.html.
22. “Opencalais,” http://opencalais.com/.
23. “Common vulnerabilities and exposures,” http://cve.mitre.org/.
24. J. Carroll, I. Dickinson, C. Dollin, D. Reynolds, A. Seaborne, and K. Wilkinson, “The JENA Semantic Web platform: architecture and design,” HP Laboratories, Tech. Rep. Technical Report HPL-2003-146, 2003.
25. A. Joshi, R. Lal, T. Finin, and A. Joshi, “Extracting cybersecurity related linked data from text. In Seventh IEEE International Conference on Semantic Computing,” IEEE Computer Society, September 2013.
26. “Stanford NER,” http://nlp.stanford.edu/software/CRF-NER.shtml.
27. R. Lal, “Annotations of cybersecurity blogs and articles,” http://ebiquity.umbc.edu/r/355, June 2013.
28. P. Stenetorp, S. Pyysalo, G. Topi′c, T. Ohta, S. Ananiadou, and J. Tsujii, “BRAT: a web-based tool for NLP-assisted text annotation,” in Demonstrations, 13th Conf. of the European Chapter of the Association for Computational Linguistics. Association for Computational Linguistics, 2012, pp. 102-107.
29. “BRAT Annotation Tool,” http://brat.nlplab.org/index.html.

What is claimed is:

1. A method of detecting a potential cyber threat or attack, comprising:
receiving data from at least two data sources;
extracting information from the received data;
asserting the information extracted using an ontology;
accumulating the asserted information; and
determining if a cyber threat or attack is present based on the received data, the accumulated asserted information and reasoning logic rules, wherein the reasoning logic rules comprise rules that correlate at least two separate and/or distinct data sources.

2. The method of claim 1, wherein at least one data source comprises a nontraditional data source.

3. The method of claim 2, wherein the data received from the nontraditional data source comprises structured text data.

4. The method of claim 3, wherein the structured text data comprises an XML data feed.

5. The method of claim 3, wherein the nontraditional data source comprises a vulnerability management data repository.

6. The method of claim 2, wherein the data received from the nontraditional data source comprises unstructured text data.

7. The method of claim 6, wherein the nontraditional data source comprise at least one of a blog, an online forum, a hacker forum, a chat room, a security bulletin, a structured database and a semi-structured database.

8. The method of claim 6, wherein information extracted from the unstructured text data comprises named entities.

9. The method of claim 1, wherein the ontology comprises a means class, a consequence class and a target class.

10. The method of claim 1, wherein the accumulated asserted information is encoded in Notation-3 format.

11. The method of claim 10, wherein the accumulated asserted information is encoded in Web Ontology Language and Resource Description Framework assertions.

12. The method of claim 1, wherein the reasoning logic rules are expressed using the ontology.

13. The method of claim 1, wherein at least one data source comprises a traditional data source.

14. The method of claim 13, wherein the traditional data source comprises at least one of a network activity monitor, a hardware security monitor, an intrusion detection system, an intrusion prevention system and a host based activity monitor.

15. An intrusion detection system, comprising:
a collaborative processing system adapted to receive data from at least two data sources;
an ontology comprising a set of computer readable instructions stored in a tangible medium that are executable by a processor; and
reasoning logic rules comprising a set of computer readable instructions stored in a tangible medium that are executable by a processor, wherein the reasoning logic rules comprise rules that correlate at least two separate and/or distinct data sources;
wherein the collaborative processing system is further adapted to extract information from the received data, assert the extracted information using the ontology, accumulate the asserted information and determine if a cyber threat or attack is present based on the received data, the accumulated asserted information and the reasoning logic rules.

16. The system of claim 15, wherein the collaborative processing system comprises:
an ontology module;
a reasoning logic module; and
a knowledge base module.

17. The system of claim 15, wherein at least one data source comprises a nontraditional data source.

18. The system of claim 17, wherein the data received from the nontraditional data source comprises structured text data.

19. The system of claim 18, wherein the structured text data comprises an XML data feed.

20. The method of claim 17, wherein the nontraditional data source comprises a vulnerability management data repository.

21. The system of claim 17, wherein the data received from the nontraditional data source comprises unstructured text data.

22. The system of claim 21, wherein the nontraditional data source comprise at least one of a blog, an online forum, a hacker forum, a chat room, a security bulletin, a structured database and a semi-structured database.

23. The system of claim 21, wherein information extracted from the unstructured text data comprises named entities.

24. The system of claim 15, wherein the ontology comprises a means class, a consequence class and a target class.

25. The system of claim 15, wherein the accumulated asserted information is encoded in Notation-3 format.

26. The method of claim 25, wherein the accumulated asserted information is encoded in Web Ontology Language and Resource Description Framework assertions.

27. The system of claim 15, wherein the reasoning logic rules are expressed using the ontology.

28. The system of claim 15, wherein at least one data source comprises a traditional data source.

29. The system of claim 28, wherein the traditional data source comprises at least one of a network activity monitor, a hardware security monitor, an intrusion detection system, an intrusion prevention system and a host based activity monitor.
